(19) United States
(12) Patent Application Publication
(10) Pub. No.: US 2011/0067278 A1
(43) Pub. Date: Mar. 24, 2011

(54) VISOR MOUNTED PIVOTAL DISPLAY HOLDER FOR HANDICAPPED PARKING PERMIT

(76) Inventor: Sandra Hulbert, Murrieta, CA (US)

(21) Appl. No.: 12/566,599

(22) Filed: Sep. 24, 2009

(51) Int. Cl. G09F 21/04

(52) U.S. Cl. 40/593

(57) ABSTRACT

A placard holding device can be a clear sleeve or a board with clips and a clip assembly that attaches to a vehicle sun visor. The assembly consists of a locking pivot mechanism to hold the placard securely in the up or down position. A knob or protruding ridge or bar is attached to the placard holding device sufficiently large for ease of griping to rotate the placard between a visible position for parking and a position against the visor out of the line of sight of the driver for driving.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to vehicle carried signs which are mounted in the interior of the vehicle and particularly to a pivoting handicapped parking permit display device which may comprise a clear plastic sleeve for holding a handicapped sign, a clip for mounting the sleeve on a car sun visor, a pivot device connecting the clip and sleeve which clicks to lock the sleeve in an upward storage or a downward viewing position, and a large easily gripped knob or handle or protruding ridge for pivoting the clear sleeve up or down.

2. Description of Related Art Including Information Disclosed Under 37 CFR 1.97 and 1.98

Disabled parking permits usually comprise a placard which hangs from the rear view mirror of a vehicle. These hang in the driver's field of vision and can be distracting. It is desirable to provide a handicap placard holder which is easily moved by someone with limited dexterity from a down position with the handicap placard visible for parking and an up position out of the field of view of the driver. Prior art devices fail to provide a pivotable handicap placard holder which is easily moved by a user with limited dexterity between a visible display position and a position out of the line of sight of the driver

Anti-glare extensions are known in prior art which clip on to an existing vehicle sun visor and may be pivotally adjusted. Examples of such devices may be found in U.S. Pat. Nos. 2,020,585; 2,458,125; 2,542,409; 2,528,038; 2,829,919; 3,304,118; 3,351,375; 3,837,703; 3,954,297; 4,023,854; 4,167,287; 4,280,730; 4,352,519; 4,848,822; 4,982,992; 5,613,725; and 5,673,957.

U.S. Pat. No. 7,373,745, issued May 20, 2008 to Massaad, describes a visor mounted placard holder that removably holds for display an informational placard that can be viewed through the windshield of a parked vehicle, and which enables simple and quick manual repositioning into a stored position that does not obstruct the line of sight through the windshield. Only a single action step is needed to make the placard visible or invisible. The device features: a frame that removably holds the placard for display, a mounting body having a hinged connection to the frame, a clasp distal to the hinged connection for releasably clasping the frame to the body, and a clip for removable attachment to a visor of the vehicle. Examples of informational placards include: handicapped or parking passes; identifications of a parked vehicle of a member of the media/press, or of a delivery service; placards that display information about a vehicle at a car show or dealership.

U.S. Pat. No. 5,330,085, issued Jul. 19, 1994 to Horensky, claims a visor located access card holder which is intended to be removably attached to an automobile sun visor and has a pocket for the safe and convenient storage of a plastic access card. Said device is constructed of a plurality of rectangular sheets of equal size and a clip comprised of a thin, planar, rigid, substantially rectangular base and a resilient member of constant thickness and width projecting from the base having an arcuate portion then extending towards an edge of the base with an inclination towards the plane of the base such that the free end of the clip is in close proximity to the plane of the base as well as said edge of the base. The base is either held within first and second opposed plastic sheets fixedly attached to each other along the edges or fixedly attached directly to the second sheet. A third plastic sheet is attached on three edges to the second sheet; the fourth unattached edge provides an aperture of a size suitable for insertion and removal of a plastic access card. The clip member extending from the base projects through an aperture in the first sheet of plastic, if used, opposite the second and third sheets defining the pocket, and is entirely exposed. The clip member is shaped such that the arcuate portion provides the portion extending longitudinally with a resilience in the direction normal the base such that secure but removable attachment to an automobile sun visor is enabled.

U.S. Pat. No. 6,276,081, issued Aug. 21, 2001 to Shedd, discloses a placard support for vehicle visor. A mounting apparatus for vehicle identification placards is provided that can be attached to the flat inner surface of a vehicle sun visor. The placard mount optionally includes a retainer body that is pivotally mounted to a base and provides a structure through which the placard is attached to the base. The pivotal mounting of the placard and placard retainer to the base allows the placard to be moved from a visible to a non-visible position simply by rotating the retaining body around the pivotal mount. To display the placard, the user simply lowers the sun visor which contains the mounting apparatus attached to a back side of the visor and then rotates the placard from its stored horizontal position downward to a vertical display position. In this position the placard is clearly visible from the exterior, such as for communicating to the authorities that the vehicle is properly parked in space, such as a handicapped space, where only authorized placard displaying vehicles should be parked.

U.S. Patent Application #20060225330, published Oct. 12, 2006 by Dion-Winn, puts forth a visor sign having a sign with a hole and an elastic band secured to the sign through the hole. The elastic band is selected to have a length and elasticity sized for retaining the sign in a secured position on visors of vehicles, unless the driver or an occupant moves the sign to a raised storage position or a lowered display position. The sign may provide a space for writing user information or may be a permit, such as a permit for parking

U.S. Pat. No. 2,916,838, issued Dec. 15, 1959 to Campbell, is for a sign which is removably attached to a sun visor for viewing through a windshield. The sign body is held on the visor using two straps

U.S. Pat. No. 3,168,070, issued Feb. 2, 1965 to Verney, provides an inter-automobile warning sign which clips on a sun visor, which is displayed when the visor is manually flipped down by the driver.

U.S. Pat. No. 2,531,295, issued Nov. 21, 1950 to Ritchie, shows a vehicle registration card and service tally holder which may be clipped over the sun visor of a vehicle. The holder is constructed as an envelope of transparent material and provides a pocket for holding various documents.

U.S. Pat. No. 6,163,997, issued Dec. 26, 2000 to Deralas, indicates a vehicle-mountable picture frame, also disclosed is a frame that includes a front side and a back side and a pocket formed therebetween, and having an aperture at the top for inserting photographs therethrough. The frame further includes one or more display portions disposed on the front side for displaying indicia there. The frame further includes a variety of attachment mechanisms that are connected to the backside of the frame via a swiveling attachment. The attachment mechanisms are configured to attach to a variety of surfaces within a vehicle, and further to permit the interchangeability of the attachment mechanisms with a variety of other types of mechanisms.

U.S. Pat. No. D309,756, issued Aug. 7, 1990 to Lothridge, concerns the ornamental design of an advertising display holder for an automobile sun visor.

What is needed is a placard holding device with an enlarged gripping handle for a vehicle sun visor that is easily pivoted from a locked position pivoted down from the sun and easily pivoted up to a stored position on the sun visor thereby providing a convenient way for people with diminished dexterity to display a placard such as a handicap placard.

### BRIEF SUMMARY OF THE INVENTION

An object of the present invention is to provide a placard holding device with an enlarged gripping handle for a vehicle sun visor that is easily pivoted from a locked position pivoted down from the sun and easily pivoted up to a stored position on the sun visor thereby providing a convenient way for people with diminished dexterity to display a placard such as a handicap placard.

In brief, the present invention comprises a placard holding device which can be a sleeve or a base with clips and a clip assembly that attaches to the sun visor. The clip could be made of molded plastic or a spring loaded clip such as on a clip board. The assembly consists of a pivot mechanism with indentations that would match the protrusions on the placard holding device to hold the placard securely in the up or down position. A knob or protruding ridge or bar is attached to the placard holding device sufficiently large for ease of griping to rotate the placard to the desired position. The clip assembly attaches to a vehicle sun visor.

An advantage of the present invention is that it provides a convenient way for people with diminished dexterity to display a placard such as a handicap placard.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a front elevational view of the handicapped placard holding device of the present invention as if looking in through a front windshield of a vehicle with the vehicle sun visor (shown dashed) in the down position and the handicapped placard holding device in the down position exposed to view through the windshield clipped to the visor and extending from an end of the visor toward the center of the windshield away from the pivot end of the visor;

FIG. 2 is an exploded top plan view of the handicapped placard holding device of FIG. 1 showing the components of the device including the placard holding sleeve with the protruding gripping ridge, the pivot assembly and the clip attached to a vehicle visor (shown dashed);

FIG. 2A is an end elevational view of the handicapped placard holding device of FIG. 2 showing the protruding hand grip ridge and placard holding sleeve of the device;

FIG. 3 is a front elevational view of the handicapped placard holding device (shown dashed) of FIG. 1 pivoted up parallel to the end of the sun visor (shown dashed) and not visible behind the sun visor when looking in through the front windshield of the vehicle with the vehicle sun visor in the down position and the handicapped placard holding device in the up position behind the sun visor not exposed to view through the windshield showing just one side of the clip attaching the handicapped placard holding device to the visor;

FIG. 4 is a back elevational view of the back of the handicapped placard holding device of FIG. 2 from the driver's perspective with the handicapped placard holding device pivoted up parallel to the end of the sun visor (shown dashed) with the vehicle sun visor in the down position and the handicapped placard holding device in the up position behind the sun visor not exposed to view through the windshield and showing the raised hand grip ridge and a portion of the pivot device with just one edge of the clip visible attached to the end of the sun visor;

FIG. 5 is a back elevational view of the back of the handicapped placard holding device of FIG. 1 from the driver's point of view with the handicapped placard holding device pivoted down perpendicular to the end of the sun visor (shown dashed) with the vehicle sun visor in the down position and the handicapped placard holding device in the down position extending out from the end of the sun visor so the handicapped placard on the other side of the holding device is exposed to view through the windshield;

FIG. 6 is a back elevational view of the back of an alternate embodiment of the handicapped placard holding device of FIG. 2 from the driver's perspective with the handicapped placard holding device pivoted up parallel to the end of the sun visor (shown dashed) with the vehicle sun visor in the down position and the handicapped placard holding device in the up position behind the sun visor not exposed to view through the windshield and showing a knob or handle hand grip extending from an outer end of the handicapped placard holding device and a portion of the pivot device with just one edge of the clip visible attached to the end of the sun visor;

FIG. 7 is a back elevational view of the back of the alternate embodiment of the handicapped placard holding device of FIG. 6 from the driver's point of view with the handicapped placard holding device pivoted down perpendicular to the end of the sun visor (shown dashed) with the vehicle sun visor in the down position and the handicapped placard holding device in the down position extending out from the end of the sun visor so the handicapped placard on the other side of the holding device is exposed to view through the windshield and showing the knob or handle hand grip extending from the outer end of the handicapped placard holding device;

FIG. 8 is an exploded top plan view of the handicapped placard holding device of FIG. 1 showing the components of the device including the placard holding flat stiff planar board for receiving the placard resting flat against the planar board and the means for holding the placard against the planar board comprises a pair of spring loaded clips, a protruding gripping ridge extending from the back of the planar board, the pivot assembly and the clip attached to a vehicle visor (shown dashed);

FIG. 8A is an end elevational view of the handicapped placard holding device of FIG. 8 showing the protruding hand grip ridge and placard holding planar board and clips of the device;

FIG. 9 is a front elevational view of the handicapped placard holding device of FIG. 8 as if looking in through a front windshield of a vehicle with the vehicle sun visor (shown dashed) in the down position and the handicapped placard holding device in the down position exposed to view through the windshield clipped to the visor and extending from an end of the visor toward the center of the windshield away from the pivot end of the visor.

### DETAILED DESCRIPTION OF THE INVENTION

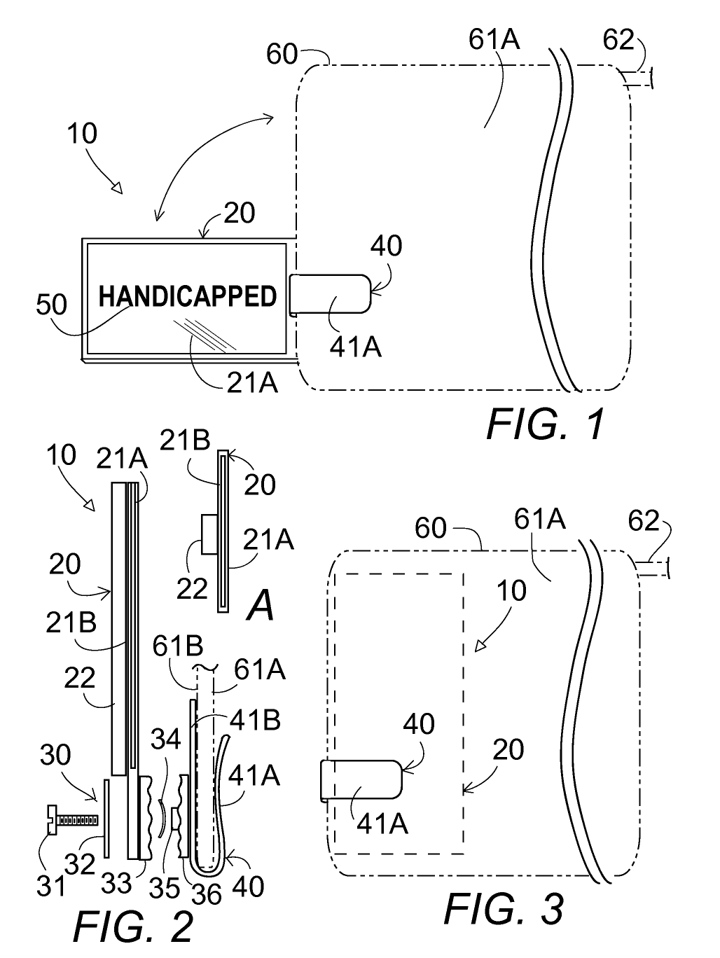

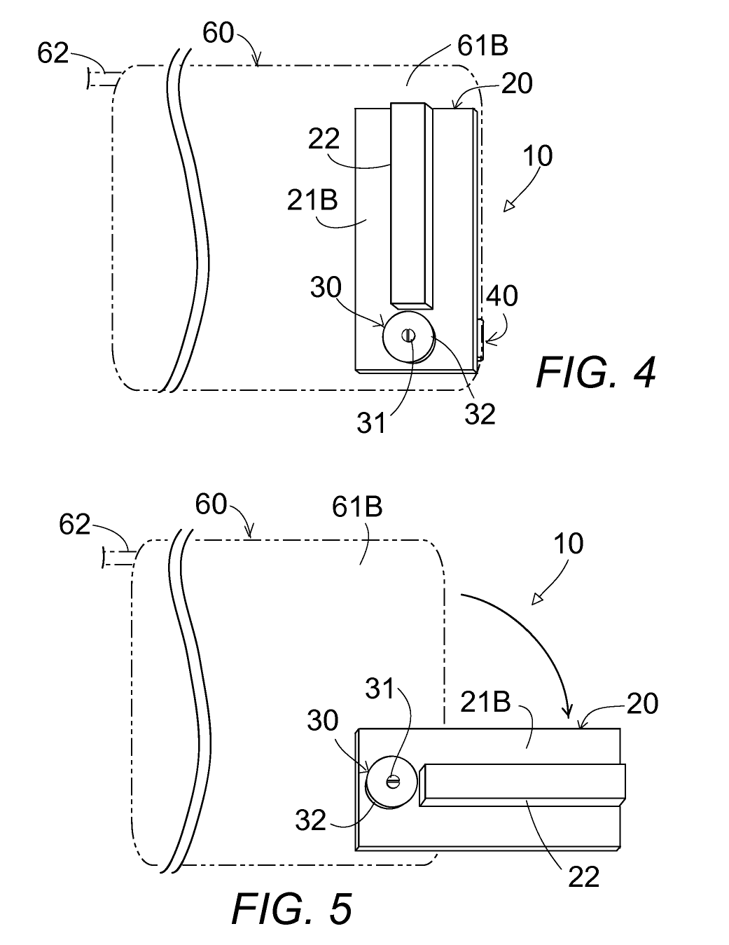

In FIGS. 1-9, a placard holding device 10 for a vehicle sun visor 60 with a pivot arm 62 attached to the vehicle provides a convenient way for people with diminished dexterity to display a handicap placard 50. The placard holding device 10 comprises a placard holder 20 for holding and displaying a placard, such as a handicapped placard 50 and an attaching device, such as a flexible clip 40 for attaching the placard holder 20 to the vehicle sun visor 60 and allowing the placard holder 20 to be pivoted down for viewing the placard such as the handicapped placard 50, as in FIG. 1.

The flat placard holder 20 comprises two opposing components for retaining a flat placard therebetween, the components comprising at least one flat face 21B and 21C for receiving a placard resting flat against the flat face and means for holding the placard against the flat face. At least one of the components provides means for viewing the placard.

In FIGS. 1-7, a self-supporting sleeve 20 comprises two flat faces 21A and 21B attached along at least a top edge and a bottom edge forming an envelope for holding the placard 50 therebetween and a least one side end opening, seen in FIG. 2A, therebetween for inserting and removing the placard 50. One of the flat faces 21A comprises a transparent sheet for viewing the placard 50 inside the envelope 20.

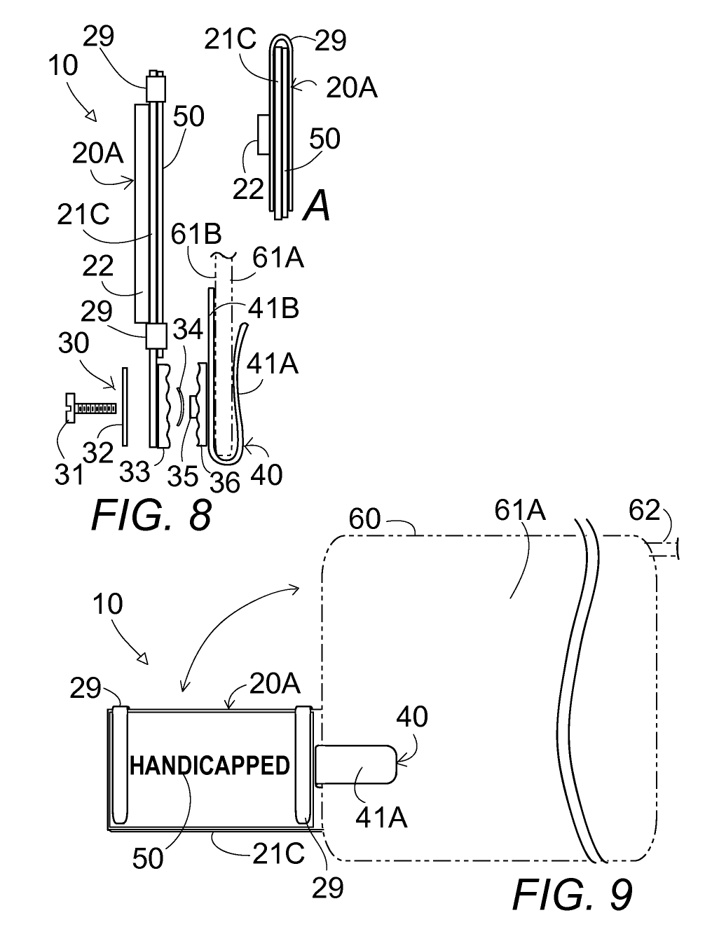

In FIGS. 8 and 9, the at least one flat face comprises a flat stiff planar board 21C for receiving the placard 50 resting flat against the board and the means for holding the placard 50 against the flat face comprises a pair of spring loaded clips 29.

A means for grasping the placard holder 20 and 20A by a user with diminished dexterity to move the placard holder between the first position and the second position may comprise a protruding ridge 22, as shown in FIGS. 2, 4, 5, and 8, extending from the back of the placard holder. The ridge is sufficiently large for ease of gripping for a user with diminished dexterity to grasp the protruding ridge 22 to move the placard holder between the first position and the second position.

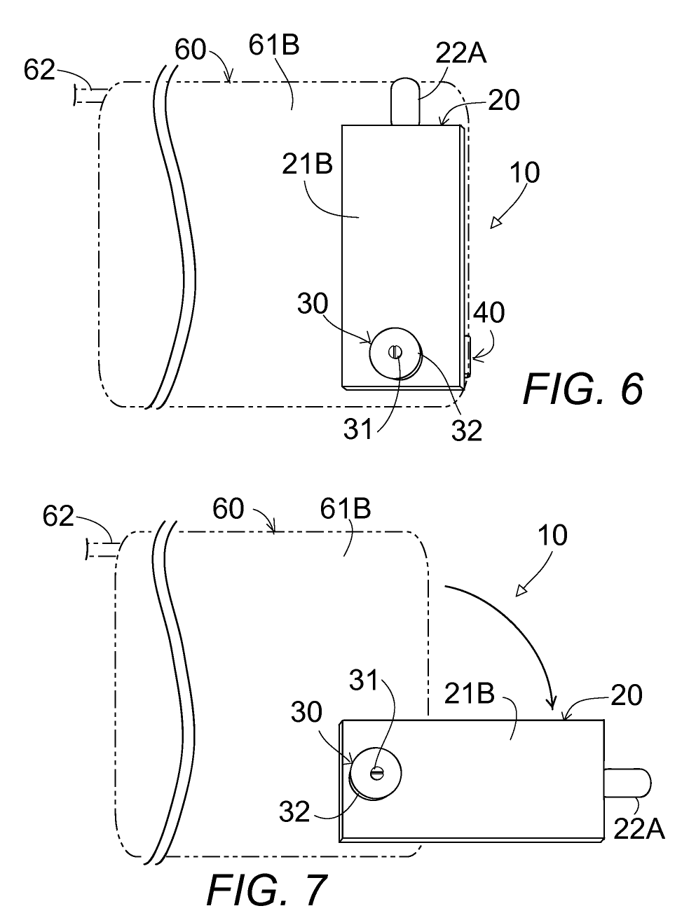

An alternate means for grasping the placard holder 20 by a user with diminished dexterity to move the placard holder between the first position and the second position comprises a handle 22A, as shown in FIGS. 6 and 7, extending from the placard holder. The handle is sufficiently large for ease of gripping for a user with diminished dexterity to grasp the handle to move the placard holder between the first position and the second position.

An attaching device for removably attaching the placard holder to a sun visor 60 in a vehicle preferably comprises a U-shaped clip 40 with two flexing sides 41A and 41B spaced apart so that they flex apart to receive the sun visor 60 therebetween and flex onto the sun visor to secure the placard holder 20 to the sun visor 60, as shown in FIGS. 2 and 8. The attaching device may alternately comprise a tension clip for removably binding the placard holder to the sun visor or a spring-loaded clip with two controlled jaws which are opened to receive the sun visor therebetween and released to secure the placard holder to the sun visor.

The attaching device further comprises a locking pivot device 30 for pivoting the placard holder 20 and 20A between a first position locked in place parallel to the visor end, as shown in FIGS. 3, 4, and 6, for storage with the placard out of the line of sight of the driver and also not visible with the visor in the up storage position and a second position locked in place perpendicular to the end of the visor for viewing the placard, as shown in FIGS. 1, 5, 7, and 9, thereby providing a placard holding device for a vehicle sun visor to provide a convenient way for people with diminished dexterity to display a handicap placard.

In FIGS. 2 and 8, the locking pivot device 30 comprises a pair of facing annular plates 33 and 36 connected by a tension device 34 therebetween and a pivot formed by a protruding pivot post 35 from one plate 36 pivoting within a mating opening in the opposite plate 33. The plates 33 and 36 have at least two spaced protrusions releasably engaging at least two spaced mating recessions between the plates which may be a mating undulating wave pattern intermeshing between the plates. A stationary plate 36 is attached to the attaching device 40 and a pivotable plate 33 is attached to the placard holder 20. The pivotable plate 33 is pivoted from one of the positions to overcome the tension device 34 to release the protrusions from the recessions and pivot the placard holder 20 and releasing the pivotable plate 33 to allow the tension device to engage the protrusions in the recessions to lock the placard holder in the other of the positions.

In use, when the vehicle is parked the sun visor 60 is pivoted downward to the sunshading position covering a portion of the windshield with the front portion 61A of the sun visor 60 facing out of the windshield. The hand grip 22 or 22A is grasped to pivot the placard holder 20 and 20A down to the viewing position of FIGS. 1, 5, 7, and 9 so that the handicapped placard 50 or other placard is visible through the windshield, as shown in FIGS. 1 and 8. When the vehicle is being driven, the placard holder 20 is pivoted up into the storage position against the back surface 61B of the sun visor out of the line of sight of the driver. When the sun visor 60 is pivoted up away from the windshield, the placard holder 20 and 20A is not visible.

It is understood that the preceding description is given merely by way of illustration and not in limitation of the invention and that various modifications may be made thereto without departing from the spirit of the invention as claimed.

What is claimed is:

1. A placard holding device for a vehicle sun visor to provide a convenient way for people with diminished dexterity to display a handicap placard, the device comprising:
a flat placard holder comprising two opposing components for retaining a flat placard therebetween, the components comprising at least one flat face for receiving a placard resting flat against the flat face and means for holding the placard against the flat face, wherein at least one of the components provides means for viewing the placard, and further comprising means for grasping the placard holder by a user with diminished dexterity to move the placard holder between the first position and the second position;
an attaching device for removably attaching the placard holder to a sun visor in a vehicle, the attaching device having a locking pivot device for pivoting the placard holder between a first position locked in place parallel to the visor for storage and a second position locked in place perpendicular to the visor for viewing the placard, thereby providing a placard holding device for a vehicle sun visor to provide a convenient way for people with diminished dexterity to display a handicap placard.

2. The device of claim 1 wherein the placard holder comprises a self-supporting sleeve comprising two flat faces attached along at least a top edge and a bottom edge forming an envelope for holding the placard therebetween and a least one side end opening therebetween for inserting and removing the placard, at least one of the flat faces comprising a transparent sheet for viewing the placard inside the envelope.

3. The device of claim 1 wherein the means for grasping the placard holder comprises a handle extending from the placard holder, the handle sufficiently large for ease of gripping for a user with diminished dexterity to grasp the handle to move the placard holder between the first position and the second position.

4. The device of claim 1 wherein the means for grasping the placard holder comprises a protruding ridge extending from the placard holder, the ridge sufficiently large for ease of gripping for a user with diminished dexterity to grasp the protruding ridge to move the placard holder between the first position and the second position.

5. The device of claim 1 wherein the locking pivot device comprises a pair of facing annular plates connected by a tension device and pivot, the plates having at least two spaced protrusions releasably engaging at least two spaced mating recessions between the plates, a stationary plate attached to the attaching device and a pivotable plate attached to the placard holder, the pivotable plate pivoted from one of the positions to overcome the tension device to release the protrusions from the recessions and pivot the placard holder and releasing the pivotable plate to allow the tension device to engage the protrusions in the recessions with the placard holder in the other of the positions.

6. The device of claim 1 wherein the attaching device comprises a tension clip for removably binding the placard holder to the sun visor.

7. The device of claim 6 wherein the attaching device comprises a U-shaped clip with two flexing sides spaced apart so that they flex apart to receive the sun visor therebetween and flex onto the sun visor to secure the placard holder to the sun visor.

8. The device of claim 6 wherein the attaching device comprises a spring-loaded clip with two controlled jaws which are opened to receive the sun visor therebetween and released to secure the placard holder to the sun visor.

9. The device of claim 1 wherein the at least one flat face comprises a flat stiff planar board for receiving the placard resting flat against the board and the means for holding the placard against the flat face comprises at least one spring loaded clip.
